(19) United States
(12) Patent Application Publication
(10) Pub. No.: US 2022/0061957 A1
(43) Pub. Date: Mar. 3, 2022

(54) AUTOMATIC BITE SETTING

(71) Applicant: James R. Glidewell Dental Ceramics, Inc., Newport Beach, CA (US)

(72) Inventors: Fedor Chelnokov, Khimki (RU); Sergey Nikolskiy, Coto de Caza, CA (US); Grant Karapetyan, Moscow (RU)

(21) Appl. No.: 17/007,922

(22) Filed: Aug. 31, 2020

(51) Int. Cl. A61C 7/00; G06T 7/70

(52) U.S. Cl. CPC A61C 7/002; B33Y 80/00; G06T 2207/30036; G06T 7/70

(57) ABSTRACT

A computer-implemented method and system of determining a bite setting include receiving first and second digital jaw models, determining a rough bite approximation of the first and second digital jaw models, determining one or more initial bite positions of the first and second digital jaw models from the rough approximation, determining one or more iterative bite positions of the first and second digital jaw models for each of the one or more initial bite positions, determining a score for each iterative bite position, and outputting the bite setting based on the score.

### BACKGROUND

Specialized dental laboratories typically use computer-aided design (CAD) and computer-aided manufacturing (CAM) milling systems when performing work for a dentist or other dental entity. To use the CAD/CAM system, a digital model of the patient's dentition can be used as an input to the process.

To generate digital models, physical impressions of the upper and the lower jaws are taken and scanned independently of each other. This can cause the spatial relationship between the upper and the lower jaws—also known as bite—to be lost in the process of scanning. Because the physical impressions are scanned separately, two separate 3D digital jaw models are generated, one for each jaw. The bite information between the upper and lower jaw is lost. It can be challenging to restore the bite setting/alignment between the upper digital jaw model and the lower digital jaw model.

### SUMMARY

Disclosed is a computer-implemented method of determining a bite setting. The method can include receiving first and second digital jaw models, determining a rough bite approximation of the first and second digital jaw models, determining one or more initial bite positions of the first and second digital jaw models from the rough approximation, determining one or more iterative bite positions of the first and second digital jaw models for each of the one or more initial bite positions, determining a score for each iterative bite position, and outputting the bite setting based on the score.

Disclosed is a system for determining a bite setting. The system can include a processor, a computer-readable storage medium comprising instructions executable by the processor to perform steps including: receiving first and second digital jaw models, determining a rough bite approximation of the first and second digital jaw models, determining one or more initial bite positions of the first and second digital jaw models from the rough approximation, determining one or more iterative bite positions of the first and second digital jaw models for each of the one or more initial bite positions, determining a score for each iterative bite position and outputting the bite setting based on the score.

Disclosed is a non-transitory computer readable medium storing executable computer program instructions for determining a bite setting, the computer program instructions including instructions for: receiving first and second digital jaw models, determining a rough bite approximation of the first and second digital jaw models, determining one or more initial bite positions of the first and second digital jaw models from the rough approximation, determining one or more iterative bite positions of the first and second digital jaw models for each of the one or more initial bite positions, determining a score for each iterative bite position, and outputting the bite setting based on the score.

### BRIEF DESCRIPTION OF THE DRAWINGS

FIG. 1(a) illustrates an example of 3D physical impressions taken independently of first jaw and second jaw.

FIG. 1(b) illustrates one example of a separate 3D first digital jaw model and a 3D second digital jaw model.

FIG. 2 illustrates an example of a 3D digital jaw model with an occlusion direction one or more cusp points connected together through a best parabola.

FIG. 3 is an illustration of detecting cusps.

FIG. 4 is an illustration of an example of detecting cusps.

FIG. 5 is an illustration of determining a parabola.

FIG. 6 is an illustration of an example of joining cusps.

FIG. 7(a) illustrates an example of a geometrical average of the first digital jaw model.

FIG. 7(b) illustrates an example of a geometrical average of the second digital jaw model.

FIG. 8(a) illustrates a first 3D digital jaw model with a digital jaw model center, forward shifted digital jaw model point, and a side-shifted digital jaw model point.

FIG. 8(b) illustrates a second 3D digital jaw model with a digital jaw model center, forward shifted digital jaw model point, and a side-shifted digital jaw model point.

FIG. 9(a) illustrates an example of a 3D first digital jaw model with parabola.

FIG. 9(b) illustrates an example of a 3D second digital jaw model with parabola.

FIG. 10 illustrates an example of aligning the one or more first 3D digital jaw model points and the one or more second 3D digital jaw model points where the points are shifted.

FIG. 11 illustrates an example of first digital jaw model with initial positions.

FIG. 12(a) illustrates extended regions a first digital jaw model and a second digital jaw model.

FIG. 12(b) illustrates smaller regions for the first digital jaw model and the second digital jaw model.

FIG. 13 illustrates an example of the computer-implemented method forming one or more attractive weighted set of point pairs.

FIG. 14 illustrates an example of forming an interpenetration weighted set of point pairs in some embodiments.

FIG. 15 illustrates an example of penetration fixing iteration in some embodiments.

FIG. 16 illustrates an example of a function that can be applied to the signed distance of each vertex to determine the score of each vertex.

FIG. 17 illustrates an example of output bite position by the computer-implemented method in some embodiments.

FIG. 18 illustrates a flowchart in some embodiments.

FIG. 19 illustrates a processing system in some embodiments.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

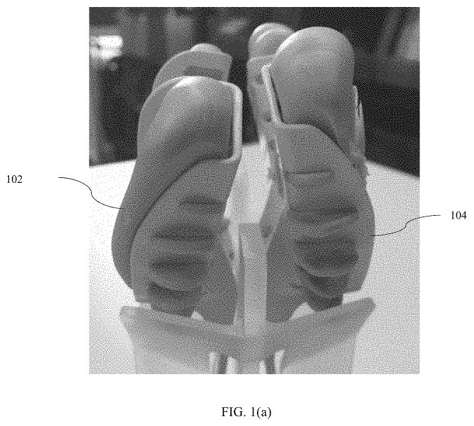

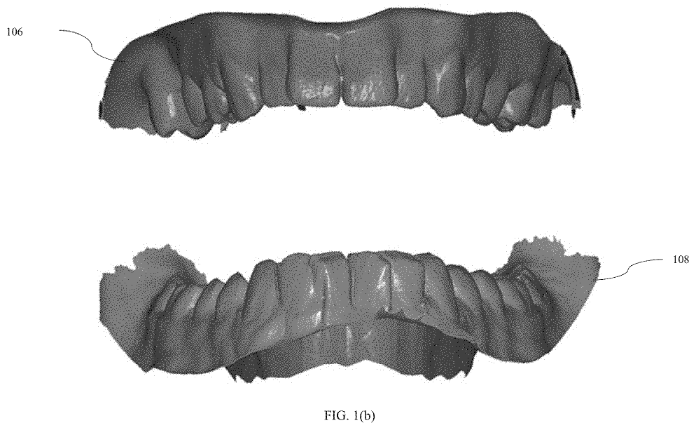

Typically, impressions of the upper and the lower jaws are taken and scanned independently. FIG. 1(a) illustrates physical impressions taken independently of first jaw and second jaw, for example. The first jaw impression 102 and second jaw impression 104 can be scanned separately. Scanning the first jaw and the second jaw or their corresponding first jaw impression 102 or second jaw impression 104 can generate a digital first jaw 106 and a digital second jaw 108 as illustrated in FIG. 1(b). The spatial relation between them (also known as bite) in a patient's mouth is lost in the process of scanning. It can be advantageous to restore the bite (that is a transformation of one jaw relative to the other) given digital surfaces of two jaws.

Some embodiments include a computer-implemented method of automatically determining a bite setting between a first digital jaw model and a second digital jaw model. In some embodiments, the computer-implemented method includes receiving first and second digital jaw models. The first and second digital jaw models can be produced from an intraoral scan of a patient's dentition or from a CT scan of one or more physical dental impressions.

FIG. 1(b) illustrates one example of a first digital jaw model 106 and a second digital jaw model 108. Each digital jaw model can be generated by scanning a physical impression using any scanning technique known in the art including, but not limited to, for example, optical scanning, CT scanning, etc. or by intraoral scanning of the patient's mouth (dentition). A conventional scanner typically captures the shape of the physical impression/patient's dentition in 3 dimensions during a scan and digitizes the shape into a 3 dimensional digital model. The first digital jaw model 106 and the second digital jaw model 108 can each include multiple interconnected polygons in a topology that corresponds to the shape of the physical impression/patient's dentition, for example, for a responding jaw. In some embodiments, the polygons can include two or more digital triangles. In some embodiments, the scanning process can produce STL, PLY, or CTM files, for example that can be suitable for use with a dental design software, such as FastDesign™ dental design software provided by Glidewell Laboratories of Newport Beach, Calif. One example of CT scanning is described in U.S. Patent Application No. US20180132982A1 to Nikolskiy et al., which is hereby incorporated in its entirety by reference.

The first digital jaw model 106 and the second digital jaw model 108 can also be generated by intraoral scanning of the patient's dentition, for example. In some embodiments, each electronic image is obtained by a direct intraoral scan of the patient's teeth. This will typically take place, for example, in a dental office or clinic and be performed by a dentist or dental technician. In other embodiments, each electronic image is obtained indirectly by scanning an impression of the patient's teeth, by scanning a physical model of the patient's teeth, or by other methods known to those skilled in the art. This will typically take place, for example, in a dental laboratory and be performed by a laboratory technician. Accordingly, the methods described herein are suitable and applicable for use in chair side, dental laboratory, or other environments.

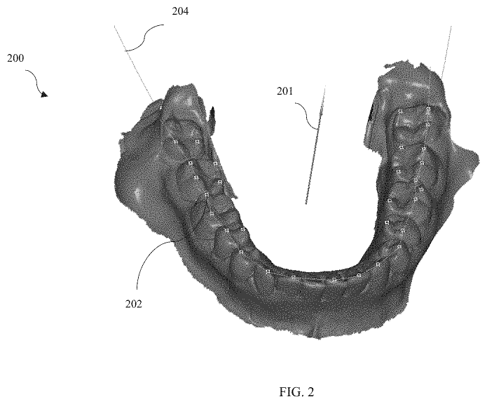

In some embodiments, the computer-implemented method determines a rough bite approximation of the first and second digital jaw models. In some embodiments, determining the rough bite approximation can include determining an axial rough bite approximation. Determining an axial rough bite approximation can include determining first and second digital jaw model occlusion directions, determining first and second digital jaw model cusp points, and determining a first and second digital jaw model best parabola of the first and second digital jaw model cusp points. FIG. 2 illustrates an example of an occlusion direction 201, and one or more cusp points 202 connected together through a best parabola 204 on a first digital jaw model 200. In some embodiments, the same features can be determined on the other digital jaw model, for example.

The occlusal direction is a normal to an occlusal plane and the occlusal plane can be determined for the digital model using any technique known in the art. For example, one technique is described in AN AUTOMATIC AND ROBUST ALGORITHM OF REESTABLISHMENT OF DIGITAL DENTAL OCCLUSION, by Yu-Bing Chang, James J. Xia, Jaime Gateno, Zixiang Xiong, Fellow, IEEE, Xiaobo Zhou, and Stephen T. C. Wong in IEEE TRANSACTIONS ON MEDICAL IMAGING, VOL. 29, NO. 9, September 2010, the entirety of which is incorporated by reference herein. Alternatively, in some embodiments, the occlusal direction can be specified by a user using an input device such as a mouse or touch screen to manipulate the digital model on a display, for example, as described herein. In some embodiments, the occlusal direction can be determined, for example, using the Occlusion Axis techniques described in PROCESSING DIGITAL DENTAL IMPRESSION U.S. patent application Ser. No. 16/451,968, of Nikolskiy et al., the entirety of which is incorporated by reference herein.

The one or more cusp points 202 can be determined using any technique known in the art. The one or more cusp points 202 can also be determined based on certain criteria, such as having the highest curvature, based on a height, or height to radius ratio.

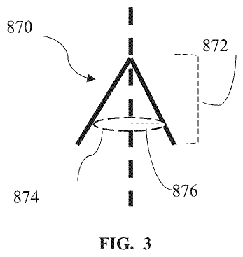

For example, as shown in the example of FIG. 3, the computer-implemented method can in some embodiments detect cusps by determining one or more peaks 870, which can be determined based on a height 872 and a neighborhood radius 876 of perimeter 874 on a given tooth. The perimeter 874 in some embodiments is an empirically set value. In some embodiments, the height 872 to radius 876 ratio is determined and if the height to radius ratio approximately equal to 1, then the peak 870 is identified as a cusp by the computer-implemented method. This can help distinguish a cusp from a ridge, for example.

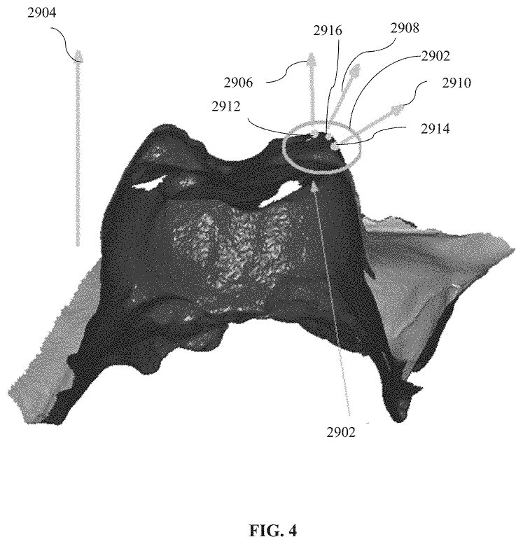

In some embodiments, the computer-implemented method can detect tooth cusps by determining local maxima by directions as illustrated in the example of FIG. 4. In some embodiments, the computer-implemented method can determine directions 2906, 2908, and 2910. In some embodiments, at least one direction can be along the occlusion axis 2904. For example, direction 2906 can be along the occlusion direction 2904. For each selected direction, the computer-implemented method determines local surface maxima in the direction. For example, as illustrated in the figure, local maximum 2912 is determined along direction 2906, local maximum 2916 is determined along direction 2908, and local maximum 2914 is determined along direction 2910. In some embodiments, the computer-implemented method can determine the local surface maxima in a particular direction (“maxima” or “directional maxima”) by determining all vertices in a neighborhood of a selected radius of a local maximum having a lower projection (i.e. height) along the direction than the local directional maxima. The computer-implemented method can form a cluster of points 2902 of local directional maxima. In some embodiments, each cluster can include one or more local directional maxima. In some embodiments, the one or more several directional maxima can be for one or more directions. In some embodiments, a close group can be designated as two or more directional maxima at or below a threshold distance that can be set by a user and used to process every digital image automatically. In some embodiments, the threshold distance can be in the range of 0 to 1 mm. A cluster can be designated as at least K directional maxima in the close group, where K is a user-selectable value specifying the number of directional maxima in the close group necessary to form a cluster. The computer-implemented method can define cusp-points as centers of clusters containing at least K directional maxima. Decreasing the value of K can lead to detection of more cusps on the digital surface, and increasing K can decrease the number of cusps found, for example. For example, setting the value of K to 5 requires at least 5 directional maxima within the close group distance to form a cluster. The computer-implemented method can determine the center of the cluster to be the cusp-point. If in the example only 4 or fewer directional maxima were located within the close group distance, then the computer-implemented method would not determine the 4 or fewer directional maxima to be a cluster.

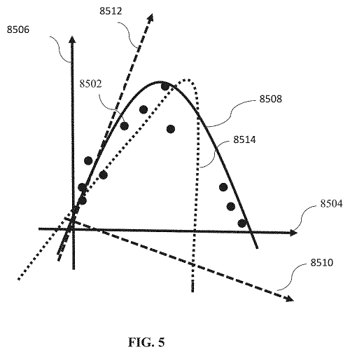

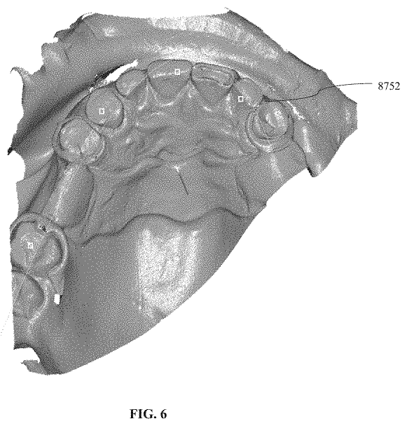

In some embodiments, the computer implemented method can join the one or more dental features by the best fit smooth curve such as a best fit analytical curve such as, for example, a parabola. To determine the best fit parabola, the computer-implemented method determines the least-squares plane for all digital dental features. For example, in the case of cusps, the computer-implemented method projects the tooth cusps onto the plane. For example, as illustrated in FIG. 5, cusps 8502 (illustrated as black dots in the figure) are arranged in the least-squares plane. The computer-implemented method generates a first x-axis 8504 in a first direction in the plane and determines a first y-axis 8506 ninety degrees to the x-axis in the plane. The computer implemented method determines coefficients a, b, and c in the formula y=ax²+bx+c using the Quadratic Least Square Regression known in the art. For example, parabola 8508 can be determined by the computer-implemented method after determining coefficients a, b, and c. The computer-implemented method then determines the discrepancy between the parabola 8508 and the cusps 8502, for example. The computer-implemented method repeats the steps for a user-selectable number of x-axis directions. For example, the computer-implemented method can rotate the x-axis 8504 by an x-axis rotation to a new x-axis 8510 with corresponding y-axis 8512 to determine parabola 8514. In some embodiments, the number of x-axis directions can be a user-selectable and/or pre-defined value. In some embodiments, the number of x-axis directions can be 100, for example. The computer-implemented method can select the parabola with the smallest discrepancy where a is not more than 150 meter⁻¹, for example, to avoid very sharp parabolas. In some embodiments, the computer-implemented method optionally eliminates cusps located farther than a user-selectable and/or pre-defined maximum cusp distance, which can be any value. In some embodiments, the maximum cusp distance can be, for example, 5 mm. As illustrated in FIG. 6, the computer-implemented method can join tooth cusps by the best fit parabola 8752.

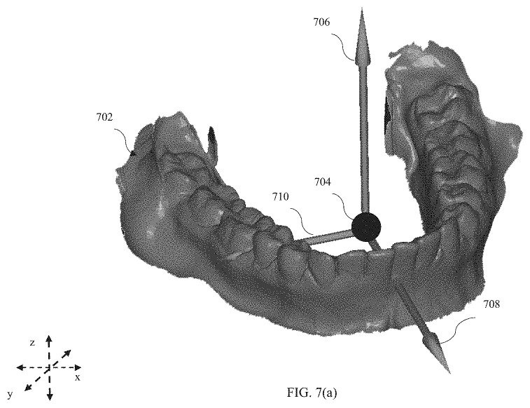

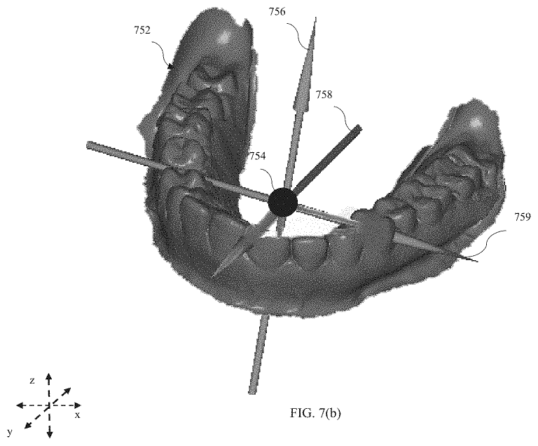

In some embodiments, the computer-implemented method can determine axial rough approximation. In some embodiments, determining the axial rough bite approximation can include determining a first digital jaw model center and a second digital jaw model center. In some embodiments, the first digital jaw center can be a geometrical average of the first digital jaw model digital surface points and the second digital jaw model center can be a geometrical average of the second digital jaw model surface points. FIG. 7(a) illustrates an example of a geometrical average of the first digital jaw model 702 having an occlusion direction 706, side direction 710, and a forward direction 708. The computer-implemented method can take an average of all digital surface points on the first digital jaw model 702 to determine first digital jaw model center 704. The same process can be repeated for the second digital jaw model. The computer-implemented method can take an average of all digital surface points on the second digital jaw model and determine an x-y-z average. FIG. 7(b) illustrates an example of a geometrical average of the second digital jaw model 752. The computer-implemented method can take an average of all digital surface points on the second digital jaw model 752 to determine second digital jaw model center 754.

In some embodiments, determining the rough approximation can include determining first and second digital jaw model occlusal directions, first and second digital jaw model forward directions, and first and second digital jaw model side directions.

FIG. 7(a) illustrates an occlusion direction 706, forward direction 708, and side direction 710, each passing through the first digital jaw model center 704. The computer-implemented method can determine the occlusion direction 706 as described previously in the present disclosure. In some embodiments, the forward direction can be determined from the best fit parabola 204 from FIG. 2. In some embodiments, the computer-implemented method can determine the forward direction 708 as an axis of symmetry passing through a vertex of the best fit parabola 204 and the first digital jaw model center 704 shown in FIG. 7(a). In some embodiments, the side direction 710 of the first digital jaw model 702 can be determined as a cross product of the occlusal direction 706 and the forward direction 708.

FIG. 7(b) illustrates an occlusion direction 756, forward direction 758, and side direction 759, each passing through the second digital jaw model center 754. The computer-implemented method can determine the occlusion direction 756 as described previously in the present disclosure. In some embodiments, the forward direction can be determined from the best fit parabola 204 from FIG. 2. In some embodiments, the computer-implemented method can determine the forward direction 758 as an axis of symmetry passing through a vertex of the best fit parabola 204 and the second digital jaw model center 754 shown in FIG. 7(b). In some embodiments, the side direction 759 of the second digital jaw model 752 can be determined as a cross product of the forward direction 758 and the occlusal direction 756 (reverse order of arguments versus the first digital jaw model).

In some embodiments, determining the rough approximation can include determining an alignment of one or more first digital jaw model points with one or more second digital jaw model points.

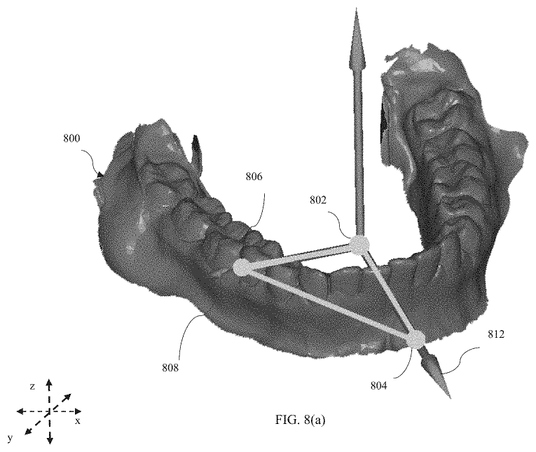

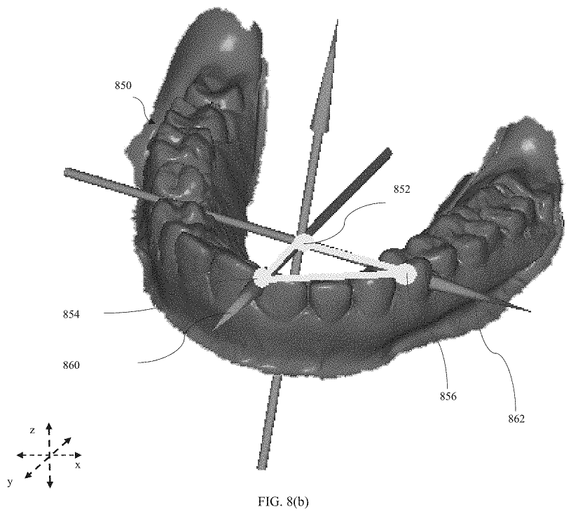

In some embodiments, the computer-implemented method can determine one or more first digital jaw model points such as the first digital jaw model center 802, a forward-shifted first digital jaw model point 804, and a side-shifted first digital jaw model point 806 of a first digital jaw model 800 illustrated in the example of FIG. 8(a). In some embodiments, the forward-shifted first digital jaw model point 804 is determined by the computer-implemented method by shifting from the first digital jaw model center 802 by a forward shift distance along the forward direction 812. In some embodiments, the forward shift distance can be 2 cm, for example. In some embodiments, the side-shifted first digital jaw model point 806 is determined by the computer-implemented method by shifting along a side shift direction 808 from the first digital jaw model center 802 by a side-shift distance. In some embodiments, the side-shift distance can be 2 cm.

In some embodiments, the one or more second digital jaw model points can include the second digital jaw model center 852, a forward-shifted second digital jaw model point 854, and a side-shifted second digital jaw model point 856 a second digital jaw model 850 illustrated in the example of FIG. 8(b). The forward-shifted second digital jaw model point 854 can be determined by the computer-implemented method by shifting from the second digital jaw model center 852 by a forward shift distance along the forward direction 860. In some embodiments, the forward shift distance can be 2 cm. In some embodiments, the side-shifted second digital jaw model point 856 can be determined by the computer-implemented method by shifting along a side shift axis 862. from the second digital jaw model center 852 by a side-shift distance. In some embodiments, the side-shift distance can be 2 cm.

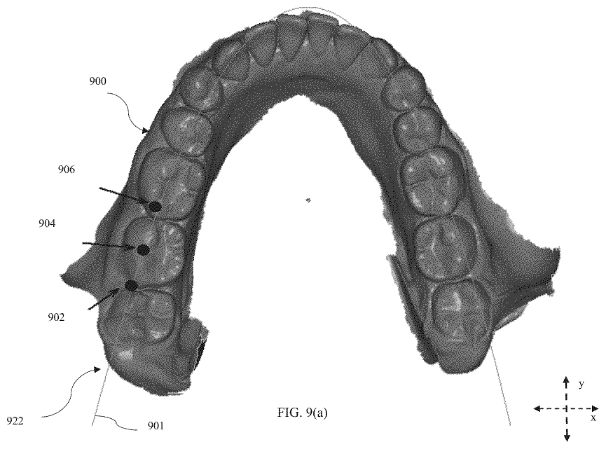

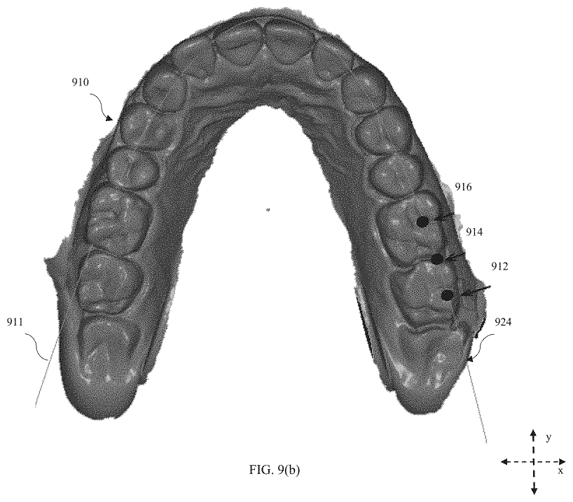

In some embodiments, the computer-implemented method can determine one or more first digital jaw model points by sampling the first digital jaw model parabola points and can determine one or more second digital jaw model points by sampling points on the second digital jaw model parabola points. FIG. 9(a) illustrates an example of a first digital jaw model 900 with parabola 901. The computer-implemented method can in some embodiments determine one or more sampled digital points starting on a first side 922 of the first digital jaw model 900, such as first jaw first sample point 902, first jaw second sample point 904, and first jaw third sample point 906. The computer-implemented method can similarly sample one or more second digital parabola points to determine one or more second digital jaw model points. FIG. 9(b) illustrates an example of a second digital jaw model 910 with parabola 911. The computer-implemented method can in some embodiments determine one or more sampled digital points on a second side 924 of the second digital jaw model 910, such as for example second jaw first sample point 912, second jaw second sample point 914, and second jaw third sample point 916. In some embodiments, the number of sampled points can be 100 points or more. In some embodiments, the computer-implemented method can sample points from the first digital jaw model in a direction opposite to the sampling of points from the second digital jaw model.

In some embodiments, the computer-implemented method can determine the alignment by a best transformation between the one or more first digital jaw model points and the one or more second digital jaw model points. The computer implemented method can apply the best transformation whether the first and second digital jaw model points are shifted points or sampled parabola points on each digital jaw model.

In the case of sampled parabola points, for example, the computer-implemented method can perform a best transformation between one or more sample points from the first digital jaw model and the corresponding one or more sample points in the second digital jaw model in some embodiments. In some embodiments, the computer-implemented method can pair one or more sampled points from the first digital jaw model with one or more sampled points from the second digital jaw model. In some embodiments, the computer-implemented method can pair together sampled points in the order in which they were sampled (their sample sequence number). For example, the computer-implemented method can pair the first jaw first sample point 902 and the second jaw first sample point 912, the first jaw second sample point 904 and the second jaw second sample point 914, and the first jaw third sample point 906 and the second jaw third sample point 916. The computer-implemented method can perform a best transformation to bring every sample point in the first digital jaw model 900 closer to its corresponding sample point in the second digital jaw model 910 in some embodiments.

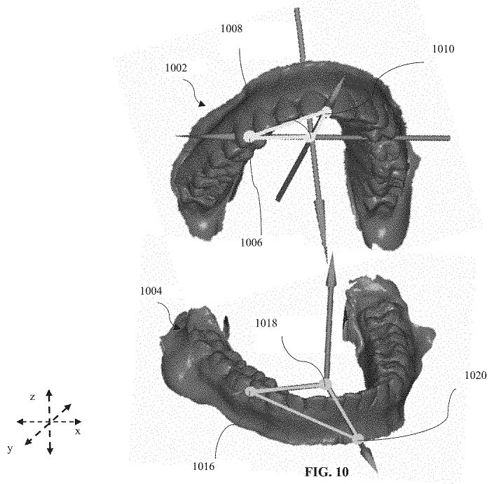

FIG. 10 shows an example of aligning the one or more first digital jaw model points and the one or more second digital jaw model points where the points are shifted. In the figure, a first digital jaw model 1002 includes one or more first digital jaw model points such as first side shifted digital jaw model point 1006, first forward shifted digital jaw model point 1010, and first center digital jaw model point 1008. Also illustrated is a second digital jaw model 1004 that can include one or more second digital jaw model points such as second side shifted digital jaw model point 1016, second forward shifted digital jaw model point 1020, and second center digital jaw model point 1018. In some embodiments, the computer-implemented method can perform a best transformation of these first and second digital jaw model points. In some embodiments, the best transformation can include:

Input: First set of points {mᵢ}, second set of points {dᵢ}, weight of each point pair wᵢ

Output: a rigid-body transformation X that minimizes

Σᵢwᵢ(dᵢ−Xmᵢ)²

In some embodiments, the best transformation is described in Estimating 3-D Rigid Body Transformations: A Comparison of Four Major Algorithms by D. W. Eggert, A. Lorusso, R. B. Fisher, Machine Vision and Applications (1997) 9: 272-290, which is hereby incorporated by reference in its entirety. In some embodiments, the best transformation is a rigid transformation. In some embodiments, the rigid transformation can include rotations and translations. For example, in some embodiments, X can include 6 independent variables. This can include, for example, translation in one or more of x-y-z directions and/or rotations around one or more of the x-y-z axes.

In some embodiments, the computer-implemented method can apply a weight to press jaws together a lower weighted number than an interpenetration prevention weight. In some embodiments, the weight to press jaws together can be 1, for example. In some embodiments, a weight to prevent deep interpenetration is greater than the weight to press jaws together. In some embodiments, higher weights can give priority of no-penetration over bringing jaws together, for example.

In some embodiments, the computer-implemented method can optionally simplify a first digital mesh of the first digital jaw model and a second digital mesh of the second digital jaw model to generate a simplified first digital mesh and a simplified second digital mesh. In some embodiments, the simplified first digital mesh can be one that deviates from the first digital mesh and the second simplified second digital mesh deviates from the second digital mesh by 0.1 mm. In some embodiments, the computer-implemented method can simplify the mesh as described in Surface Simplification Using Quadric Error Metrics by Michael Garland and Paul S. Heckbert, Carnegie Mellon University, Association for Computing Machinery, Inc., Copyright 1997, the entirety of which is hereby incorporated by reference. For example, in some embodiments, the computer-implemented method can simplify the first digital mesh and the second digital mesh by:

1. Computing the Q matrices for all the initial vertices.

2. Selecting valid pairs. The computer-implemented method can determine a valid pair where either (v₁, v₂) is an edge or ∥v₁−v₂∥<t, where t is a threshold parameter.

3. Computing the optimal contraction target v̅ for each valid pair (v₁, v₂).

The error v^{-T}(Q₁+Q₂)v̅ of the target vertex can be the cost of contracting that pair.

4. Placing all the pairs in a heap based on cost with the minimum cost pair at the top.

5. Remove, iteratively, the pair (v₁, v₂) of least cost from the heap, contract the pair, and update the costs of all valid pairs involving v₁.

In some embodiments, the computer-implemented method can determine one or more initial bite positions of the first and second digital jaw models from the rough approximation position. In some embodiments, the computer-implemented method determines one or more initial bite positions for only one of the digital jaw models. For example, in some embodiments, the computer-implemented method determines the one or more initial bite positions for the first digital jaw model. The number of initial bite positions can vary. In some embodiments, the number of initial bite positions can be nine, for example. More initial positions can allow the computer-implemented method to consider more options and find bites in some very complex cases, but can also lead to longer computations. Smaller number of initial positions can result in faster processing but can sometimes miss finding a good bite. In some embodiments, the computer-implemented method can consider initial positions not only shifted along X and Y relative to the rough approximation, but also shifted along Z or rotated along X, Y, Z.

In some embodiments, a first initial bite position can be the rough bite approximation. In some embodiments, additional initial bite positions can include forward direction shifts and the side direction shifts from the rough bite approximation of the first digital jaw model. The forward direction shifts and the side direction shifts can be any suitable distance. In some embodiments, a forward direction shift distance is greater than a side direction shift distance. In some embodiments, the forward direction shift distance can be twice the value of the side shift distance, for example. In some embodiments, the forward direction shift distance can be plus and minus 10 mm along a forward direction from the rough bite approximation position, for example. In some embodiments, the side direction shift distance can be plus and minus 5 mm along a side direction from the rough bite approximation position, for example.

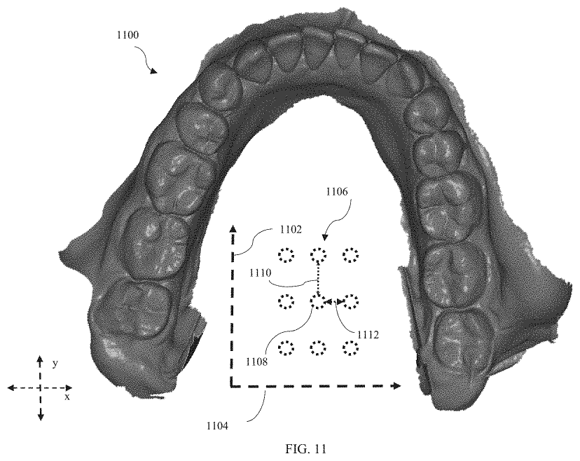

FIG. 11 illustrates an example of first digital jaw model 1100. Superimposed for illustrative purposes are a forward direction 1102 and a side direction 1104. Also shown are the one or more initial positions 1106 (marked as dotted circles). As illustrated in the figure, the first initial position can be the rough approximation position 1108. The remaining initial positions can be determined by shifting plus or minus in the forward direction 1102 by a forward shift distance 1110 and/or by shifting plus or minus in the side direction 1104 by a side shift distance 1112.

In some embodiments, the computer-implemented method can determine one or more iterative bite positions of the first and second digital jaw model for each of the one or more initial bite positions. In some embodiments, the computer-implemented method can determine an extended region and a smaller region on each of the first and second digital jaw models. In some embodiments, for example, the extended region can include one or more digital surface points less than an extended region maximum from a cusp point. In some embodiments, the one or more digital surface points can include vertices of a digital mesh. In some embodiments, for example, the extended region maximum can be 4 mm. In some embodiments, for example, the extended region maximum can prevent the extended region from reaching the gums. In some embodiments, for example, interpenetration is not allowed into the extended region. In some embodiments, for example, the smaller region can include one or more digital surface points less than a smaller region maximum from a cusp point. In some embodiments, the smaller region maximum value can be set to define a tooth region that is typically in close contact with an opposing jaw. In some embodiments, for example, the smaller region maximum can be 2 mm from each cusp point. In some embodiments, for example, a bite is adjusted to bring smaller regions from the first digital jaw model to the second digital jaw model.

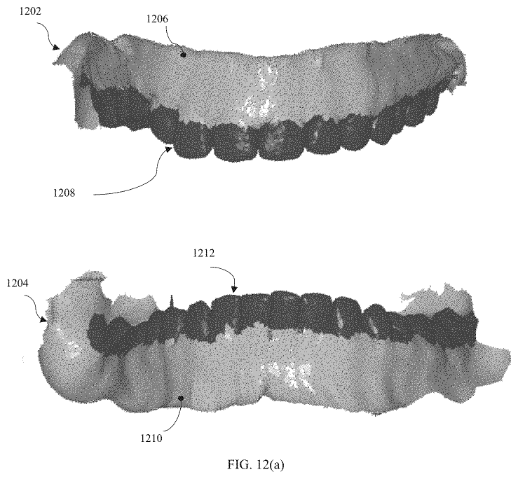

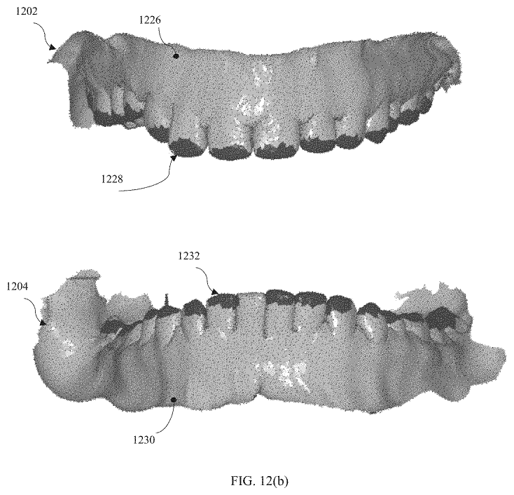

FIG. 12(a) illustrates extended regions in a first digital jaw model 1202 and a second digital jaw model 1204. The first digital jaw model 1202 can include one or more digital surface points or vertices such as, for example, vertex 1206. Based on a user selectable/definable extended region maximum, the computer-implemented method can determine extended region 1208 for the first digital jaw model 1202 by determining one or more vertices no further from cusp points than the extended region maximum. As can be seen in FIG. 12(a), the computer-implemented method can determine the first digital jaw model extended region 1208 as a region no further than an extended region distance from each cusp toward the gum line in some embodiments, for example. In some embodiments, the extended region maximum can be 4 mm, for example.

The second digital jaw model 1204 can include one or more digital surface points or vertices such as, for example, vertex 1210. Based on a user selectable/definable extended region maximum, the computer-implemented method can determine extended region 1212 for the second digital jaw model 1204 by determining one or more vertices no further from cusp points than the extended region maximum. As can be seen in FIG. 12(a), the computer-implemented method can determine the second digital jaw model extended region 1212 as a region no further than an extended region distance from each cusp toward the gum line in some embodiments, for example. In some embodiments, the extended region maximum can be 4 mm, for example.

FIG. 12(b) illustrates smaller regions for the first digital jaw model 1202 and the second digital jaw model 1204. The first digital jaw model 1202 can include one or more digital surface points or vertices such as, for example, vertex 1226. Based on a user selectable/definable small region maximum, the computer-implemented method can determine small region 1228 for the first digital jaw model 1202 by determining one or more vertices no further from cusp points than the small region maximum. As can be seen in FIG. 12(b), the computer-implemented method can determine the first digital jaw model small region 1228 as a region no further than an small region distance from each cusp toward the gum line in some embodiments, for example. In some embodiments, the small region maximum can be 2 mm, for example.

The second digital jaw model 1204 can include one or more digital surface points or vertices such as, for example, vertex 1230. Based on a user selectable/definable small region maximum, the computer-implemented method can determine small region 1232 for the second digital jaw model 1204 by determining one or more vertices no further from cusp points than the small region maximum. As can be seen in FIG. 12(b), the computer-implemented method can determine the second digital jaw model small region 1232 as a region no further than an small region distance from each cusp toward the gum line in some embodiments, for example. In some embodiments, the small region maximum can be 2 mm, for example.

In some embodiments, the computer-implemented method can perform one or more iterations to determine iterative bite positions of the first and second digital jaw model for each initial bite positions.

In some embodiments, for example, the one or more iterations can include basic iterations. The computer-implemented method can perform the one or more basic iterations by forming one or more weighted set of point pairs, the point pairs including a first digital point from the first digital jaw model and a second digital point from the second digital jaw model. In some embodiments, for example, one or more basic iterations can include forming one or more attractive weighted set of point pairs.

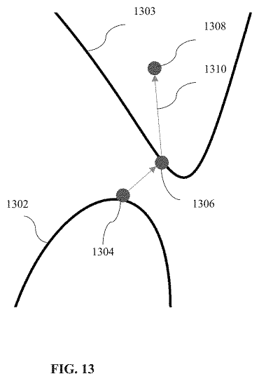

FIG. 13 illustrates an example of the computer-implemented method forming one or more attractive weighted set of point pairs. FIG. 13 shows a portion of the first digital jaw model 1302 and a portion of second digital jaw model 1303. In some embodiments, the computer-implemented method can determine a first digital point as a vertex point the first digital jaw model and determine a second digital point as an offset from a closest digital jaw model point on the second digital jaw model. In some embodiments, the offset can include an offset distance and an offset direction, for example. In some embodiments, for example, the offset is along an occlusion direction of the second digital jaw model.

For example, FIG. 13 illustrates first digital jaw model point (vertex) 1304 on the first digital jaw model 1302. In some embodiments, for example, the first digital jaw model point 1304 can be from the smaller tooth region. In some embodiments, for example, the first digital jaw model point 1304 can be from the extended tooth region. The computer-implemented method can determine closest digital point (vertex) 1306 on the second digital jaw model 1303. The closest digital point 1306 can be the digital point on the second digital jaw model 1303 that is nearest in distance to the first digital point 1304. The computer-implemented method can determine second digital point 1308 on the second digital jaw model 1303 as an offset distance and an offset direction from the closest digital jaw model point 1306. In some embodiments, for example, the offset direction be can along an occlusion direction of the first digital jaw model 1302, such as occlusion direction 1310 shown in the figure. In some embodiments, for example, the offset distance can be 1 mm. In some embodiments, the computer-implemented method forms the weighted set point pair between the first digital point such as first digital point 1304 from the first digital jaw model 1302 and the second digital point 1308 on the second digital jaw model 1303. In some embodiments, the computer-implemented method forms the weighted pair if the closest digital jaw model point is less than a closest point maximum. In some embodiments, the closest point maximum can be set by a user in a configuration file, for example. In some embodiments, for example, the closest digital point maximum can be 4 mm from the first digital jaw model point. In some embodiments, the closest point maximum can be used to avoid pressing in a wrong direction, such as if an opposing tooth is missing, for example.

In some embodiments, the computer-implemented method can determine a first digital point as a vertex point of the second digital jaw model and determining the second digital point as an offset from a closest digital jaw model point on the first digital jaw model. That is, the computer-implemented method can determine weighted pairs by starting with one or more digital jaw model points (vertices) from the second digital jaw model and determining the closest digital point on the first digital jaw model, and determining an offset as described previously.

The computer-implemented method can thus form one or more attractive weighted set of point pairs. In some embodiments, the computer-implemented method can apply a weight to the one or more attractive weighted set of point pairs. In some embodiments, the computer-implemented method can apply a weight of 1 to the attractive weighted set of point pairs, for example. Any other suitable value can be chosen.

In some embodiments one or more basic iterations can include forming an interpenetration weighted set of point pairs. In some embodiments, the computer-implemented method can form an interpenetration weighted set of point pairs by determining a first digital point as a vertex point of an extended tooth region of a first digital jaw model and determining a second digital point as a closest digital jaw model point on the second digital jaw model. In some embodiments, for example, the computer-implemented method can determine whether the first digital point is inside the second digital jaw model. (i.e. if the first digital surface point extends through a second digital jaw model surface). In some embodiments, for example, interpenetration pairs can be based on a normal to the closest digital jaw model point. One example of determining whether the first digital point is inside the second digital jaw model is described in Signed Distance Computation using the Angle Weighted Pseudo-normal, J. Andreas Bærentzen and Henrik Aanæs, IEEE Transactions on Visualization and Computer Graphics (Volume: 11, Issue: 3, May-June 2005), published 21 Mar. 2005, the entirety of which is hereby incorporated by reference. For example the computer-implemented method can determine interpenetration of a point into a jaw—such as whether the first digital point is inside the second digital jaw model, for example, by:

1. For a selected point, find the closest point on the surface for which it must be determined whether the selected point is inside or outside.

2. Determine the normal of the closest point.

3. The selected point is inside if the dot product between the normal and the vector from the selected point in question to the closest point is positive.

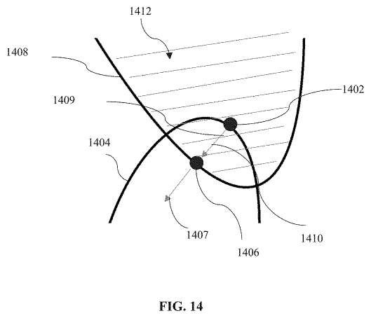

FIG. 14 illustrates an example of forming an interpenetration weighted set of point pairs in some embodiments. The computer-implemented method can select first digital point 1402, which can be a digital surface point of the first digital jaw model 1404, for example. In some embodiments, the first digital point 1402 can be vertex point from an extended tooth region, for example. The computer-implemented method can determine a second digital point 1406 on the second digital jaw model 1408 that is closest to the first digital jaw model point 1402. In some embodiments, the computer-implemented method can determine whether the first digital jaw model point 1402 is inside the second digital jaw model 1408 (e.g. extending into an internal second digital jaw model region 1412). For example, the computer-implemented method can determine a closest point normal 1407. The computer-implemented method can calculate the dot product between the closest point normal 1407 and a vector 1409 from the first digital jaw model point 1402 to the closest point 1406 to determine whether the first digital jaw model point 1402 is inside the second digital jaw model 1408, for example.

If the computer-implemented method determines the first digital jaw model point 1402 is inside the second digital jaw model 1408, then the computer-implemented determines whether the closest second digital jaw model point 1406 is less than a closest internal point maximum distance 1410. If the second digital jaw model point 1406 is within the closest internal point maximum distance 1410, then the computer-implemented can form an interpenetrative pair between the first digital jaw model point 1402 and the second digital jaw model point 1406 in some embodiments. In some embodiments, the closest internal point maximum distance can be 2 mm. In some embodiments, the computer-implemented method can apply a weight to the interpenetrative pair. In some embodiments, for example, the computer-implemented method can set the weight to 50 for an interpenetrative pair. In some embodiments, forming interpenetrative pairs can be skipped during initial basic iterations since the first and second digital jaw models may not be close enough together to result in interpenetrations. In some embodiments, the computer-implemented method can determine interpenetrative pairs for all digital surface points of both the first digital jaw model and the second digital jaw model, for example.

In some embodiments, the computer-implemented method can confirm interpenetration by determining whether the second digital jaw model point 1406 is inside the first digital jaw model 1404. This allows to avoid false “inside” reports if locally only one of the surfaces has self-intersections.

In some embodiments, the same operations can be performed by switching the jaws. For example, in some embodiments, the computer-implemented method can select a second digital jaw model point, determine its closest first digital jaw model point on the first digital jaw model surface, determine whether the second digital jaw model point is in an internal region of the first digital jaw model, and form an interpenetrative pair as discussed previously.

In some embodiments, the computer-implemented method can perform a best transformation of each weighted set of point pairs to generate the next iterative position. For example, in some embodiments, the computer-implemented method can perform a best transformation of the attracted weighted set pairs and the interpenetrative weighted set pairs from the basic iteration, for example. In some embodiments a number of iterations can include up to 200. In some embodiments, for example, the number of iterations can be based on cusp point changes. In some embodiments, for example, the cusp point change is less than 1 micron. In some embodiments, for example, each cusp position can be measured at the beginning and end of each iteration to determine change. In some embodiments, for example, an input of each iteration can be the output bite from the previous iteration.

In some embodiments, the computer-implemented method can perform penetration fixing iterations to resolve jaw penetrations. In some embodiments, the computer-implemented method can perform one or more penetration fixing iterations by determining a first digital point as a vertex point of the extended tooth region of the first digital jaw model, determining that the first digital point penetrates into an internal region of the second digital jaw model, and determining a second digital point as an offset from a closest digital jaw model point on the second digital jaw model. In some embodiments, the offset can be one-half of the distance between the vertex point and the closest digital jaw model point.

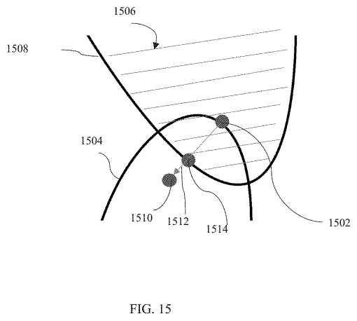

FIG. 15 illustrates an example of penetration fixing iteration in some embodiments. The computer-implemented method can select first digital point 1502 on the first digital jaw model 1504, for example. The computer-implemented method can determine the first digital point 1502 penetrates into an internal region 1506 of second digital jaw model 1508 as described previously. The computer-implemented method can determine second digital point 1510 as an offset distance 1512 from closest digital point 1514 that is on the second digital jaw model 1508. In some embodiments, the computer-implemented method can choose the second digital point 1510 located at an offset distance 1512 that is half the distance between the first digital point 1502 and the closest digital point 1514 on the second digital jaw model 1508. In some embodiments, the computer-implemented method can form a weighted interpenetration pair between the first digital point 1502 and the second digital point 1510.

In some embodiments, an input of each iteration can be the output bite from the previous iteration. In some embodiments, the computer-implemented method can apply a weight to the interpenetration pair that can be up to 15 times more than the weight of basic iteration pairs. For example, in some embodiments, the computer-implemented method can apply a weight of 750 to the interpenetration pair.

In some embodiments, the number of penetration fixing iterations can include up to 200. In some embodiments, iterations stop at a final relative position of the first digital jaw model with respect to the second digital jaw model if no cusp point moves more than a cusp movement minimum. In some embodiments, the cusp movement minimum can be 1 micron, for example. In some embodiments, the computer-implemented method can measure each cusp position at the beginning and end of each iteration to determine the change. In some embodiments, the cusp movement minimum can be a user-configurable value. In some embodiments, the cusp movement minimum can be loaded from a configuration file.

In some embodiments, the computer-implemented method can determine a score of each of the initial position bites and select the best scored bite. In some embodiments, the computer-implemented method can score each bite by summing scores of every vertex from the extended tooth region of each bite position. In some embodiments, a score of each vertex can be a function of a signed distance from the other digital jaw model, for example. In some embodiments, the sign can be positive for outside values and negative for inside values, for example. In some embodiments, scoring includes determining a score for all points from the extended tooth region from the first digital jaw model and the second digital jaw model. In some embodiments, scoring can include, for each point, determining a closest point distance with sign to a closest point on the opposing jaw. In some embodiments, scoring can include applying function to the closest point distance. In some embodiments, the function can be selected to give a better score for points in range of distances −0.2 mm to 0.4 mm. In some embodiments, the function can be selected to give a bad score to points with negative distances (meaning inside the opposite jaw) below −0.2 mm. In some embodiments, the maximum score for a point can be 1. In some embodiments, big positive distances (far away from an opposite jaw) do not change the score, for example.

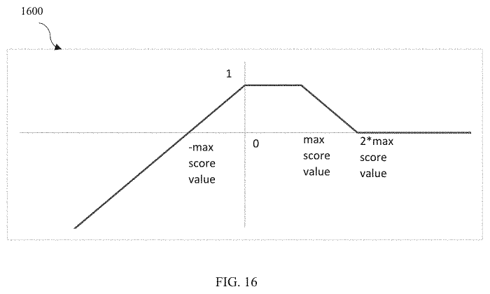

FIG. 16 illustrates an example of a function 1600 that can be applied to the signed distance of each vertex to determine the score of each vertex. Some embodiments can include the computer-implemented method setting a maximum score value, M. In some embodiments, the maximum score value can be 0.2 mm, for example. In some embodiments, the function can be selected to penalize penetrations among the jaws and promote pairs in close proximity. In some embodiments, the score can be determined as follows:

Defining the parameter M as maximal positive signed distance to the closest point on the opposite jaw, for which the score still reaches maximal value. For example, M is 0.2 mm. The score for a point with index i is defined based on its signed distance to the closest point on the opposite jaw dᵢ:

$${f}_{i} = \{ \begin{matrix}1 + \frac{{d}_{i}}{M} , if {d}_{i} < 0 \\ 1 , if 0 \leq {d}_{i} < M \\ 2 - \frac{{d}_{i}}{M} , if M \leq {d}_{i} < 2 M \\ 0 , if {d}_{i} \geq 2 M\end{matrix}$$

Then the score for a bite candidate is obtained as the sum for all vertices from extended regions on both jaws: s=Σᵢ fᵢ.

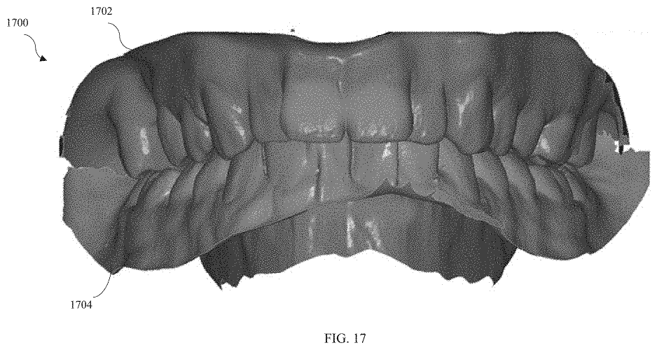

In some embodiments, the computer-implemented method can sum all values for all points from both the first digital jaw model and the second digital jaw model to determine the score of an initial bite position. In some embodiments, the computer-implemented method can output the bite position with the highest score as the bite setting. FIG. 17 illustrates an example of output bite position by the computer-implemented method in some embodiments. In some embodiments, the computer-implemented method can provide a rigid transformation of one of the digital jaw models that bring together surfaces in a correct bite setting. For example, as illustrated in FIG. 17, the digital models 1700 can include, for example, first digital jaw model 1702 and second digital jaw model 1704 as shown with the determined bite alignment.

In some embodiments, the computer-implemented method can output two digital jaw models aligned in their bite position.

In some embodiments, the computer-implemented method can determine a bite alignment between the first digital jaw model and the second digital jaw model without simulating mechanical processes guided by various physical forces. One or more advantages of this can include, for example, requiring less input data and less processing power.

In some embodiments, the computer-implemented method can receive an unsegmented first digital jaw model and an unsegmented second digital jaw model. In some embodiments, the computer-implemented method can perform bite alignment using one or more of the features/steps as disclosed herein even on the unsegmented first digital jaw model and the unsegmented second digital jaw model, for example. One or more advantages of this can include, for example, not requiring preprocessing, thereby reducing complexity and increasing speed and efficiency of determining a bite alignment, for example.

In some embodiments, the computer-implemented method can, for example, determine bite alignment using one or more features/steps as disclosed herein even if there are artifacts on the digital surface that can impede bite setting. One or more advantages of this can include, for example, accounting for such artifacts and accounting for their impact on bite setting, for example.

In some embodiments the computer-implemented method can, for example, determine interpenetration based on a closest point and signed distance without having to construct collision spots, computing collision contours between surfaces, finding spots surrounded by the contours, and/or measuring the depth of each spot. One or more advantages of one or more features disclosed can include, for example, reduced processing resources, and increased speed/efficiency. Another advantage can include, for example, the ability to support input surfaces with many degeneracies.

One or more advantages of one or more features disclosed can include, for example, requiring minimal information on input (just upper and lower jaw surfaces). Another advantage of one or more features disclosed can include, for example, not requiring additional bite scan information, or additional photos, or the type of malocclusion on input. Another advantage can include, for example, no surface preprocessing (teeth segmentation, watertight tooth models creation, removal of surface degeneracies or self-intersections, etc.). Another advantage can include, for example, full automation and best bite selection automatically, without asking for operator input and selection. One or more advantages can include, for example, increase efficiency and empirical determination of bite alignment of separated upper and lower digital jaw models, including, but not limited to, for example, situations where no bite alignment information is available.

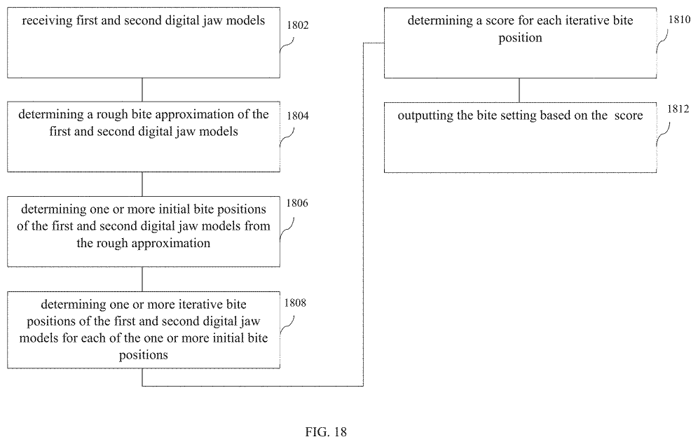

FIG. 18 illustrates a flow chart of a computer-implemented method of a computer-implemented method of determining a bite setting in some embodiments, for example. The computer-implemented method can include receiving first and second digital jaw models at 1802, determining a rough bite approximation of the first and second digital jaw models at 1804, determining one or more initial bite positions of the first and second digital jaw models from the rough approximation at 1806, determining one or more iterative bite positions of the first and second digital jaw model for each of the one or more initial bite positions at 1808, determining a score for each iterative bite position at 1810, and outputting the bite setting based on the score at 1812.

The method can in some embodiments include one or more of the following optional features, alone or in combination. For example, determining one or more iterative bite positions can include determining a best transformation of one or more paired points at each iteration. For example, the best transformation of one or more paired points at an iteration can be used as the initial bite position in the next iteration. The one or more paired points can include an attraction weighted pair. The one or more paired points can include an interpenetration weighted pair. The method can further include performing penetration fixing iterations. For example, determining the rough bite approximation can include determining an axial rough bite approximation. Determining the rough bite approximation can include determining a parabolic rough bite approximation. Determining one or more initial bite positions can include performing forward direction shifts and side direction shifts from the rough bite approximation of the first digital jaw model. Determining the score can include summing vertex scores from an extended tooth region, wherein each vertex score can be a function of a signed distance from the other jaw. The signed distance can include positive values outside and negative values inside.

Some embodiments include a processing system for determining a bite setting, including: a processor, a computer-readable storage medium including instructions executable by the processor to perform steps including: receiving first and second digital jaw models, determining a rough bite approximation of the first and second digital jaw models, determining one or more initial bite positions of the first and second digital jaw models from the rough approximation, determining one or more iterative bite positions of the first and second digital jaw model for each of the one or more initial bite positions, determining a score for each iterative bite position and outputting the bite setting based on the score.

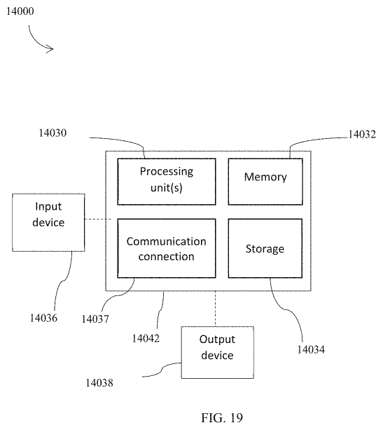

FIG. 19 illustrates a processing system 14000 in some embodiments. The system 14000 can include a processor 14030, computer-readable storage medium 14034 having instructions executable by the processor to perform one or more steps described in the present disclosure.

In some embodiments, the computer-implemented method can allow the input device to manipulate the digital model displayed on the display. For example, in some embodiments, the computer-implemented method can rotate, zoom, move, and/or otherwise manipulate the digital model in any way as is known in the art. In some embodiments, bite alignment using one or more features disclosed herein can be initiated, for example, using techniques known in the art, such as a user selecting another button.

In some embodiments, the computer-implemented method can display a digital model on a display and receive input from an input device such as a mouse or touch screen on the display for example. For example, the computer-implemented method can receive a first digital jaw model and a second digital jaw model. The computer-implemented method can, upon receiving a bite alignment initiation command, perform bite alignment using one or more features described in the present disclosure. The computer-implemented method can, upon receiving manipulation commands, rotate, zoom, move, and/or otherwise manipulate the digital model in any way as is known in the art.

One or more of the features disclosed herein can be performed and/or attained automatically, without manual or user intervention. One or more of the features disclosed herein can be performed by a computer-implemented method. The features—including but not limited to any methods and systems—disclosed may be implemented in computing systems. For example, the computing environment 14042 used to perform these functions can be any of a variety of computing devices (e.g., desktop computer, laptop computer, server computer, tablet computer, gaming system, mobile device, programmable automation controller, video card, etc.) that can be incorporated into a computing system comprising one or more computing devices. In some embodiments, the computing system may be a cloud-based computing system.

For example, a computing environment 14042 may include one or more processing units 14030 and memory 14032. The processing units execute computer-executable instructions. A processing unit 14030 can be a central processing unit (CPU), a processor in an application-specific integrated circuit (ASIC), or any other type of processor. In some embodiments, the one or more processing units 14030 can execute multiple computer-executable instructions in parallel, for example. In a multi-processing system, multiple processing units execute computer-executable instructions to increase processing power. For example, a representative computing environment may include a central processing unit as well as a graphics processing unit or co-processing unit. The tangible memory 14032 may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage 14034, one or more input devices 14036, one or more output devices 14038, and one or more communication connections 14037. An interconnection mechanism such as a bus, controller, or network, interconnects the components of the computing environment. Typically, operating system software provides an operating environment for other software executing in the computing environment, and coordinates activities of the components of the computing environment.

The tangible storage 14034 may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage 14034 stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media 14034 (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers) (e.g., the computer-executable instructions cause one or more processors of a computer system to perform the method). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media 14034. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, Python, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosure may be applied, it should be recognized that the illustrated embodiments are only examples and should not be taken as limiting the scope of the disclosure.

What is claimed is:

1. A computer-implemented method of determining a bite setting, comprising:
receiving first and second digital jaw models;
determining a rough bite approximation of the first and second digital jaw models;
determining one or more initial bite positions of the first and second digital jaw models from the rough approximation;
determining one or more iterative bite positions of the first and second digital jaw models for each of the one or more initial bite positions;
determining a score for each iterative bite position; and
outputting the bite setting based on the score.

2. The method of claim 1, wherein determining one or more iterative bite positions comprises determining a best transformation of one or more paired points at each iteration.

3. The method of claim 2, wherein the best transformation of one or more paired points at an iteration is used as the initial bite position in the next iteration.

4. The method of claim 2, wherein the one or more paired points comprises an attraction weighted pair.

5. The method of claim 2, wherein the one or more paired points comprises interpenetration weighted pair.

6. The method of claim 1, further comprising performing penetration fixing iterations.

7. The method of claim 1, wherein determining the rough bite approximation comprises determining an axial rough bite approximation.

8. The method of claim 1, wherein determining rough bite approximation comprises a parabolic rough bite approximation.

9. The method of claim 1, wherein determining one or more initial bite positions comprises performing forward direction shifts and side direction shifts from the rough bite approximation of the first digital jaw model.

10. The method of claim 1, wherein determining the score comprises summing vertex scores from an extended tooth region, wherein each vertex score is a function of a signed distance from the other jaw.

11. The method of claim 10, wherein the signed distance comprises positive values outside and negative values inside.

12. A system for determining a bite setting, comprising:
a processor;
a computer-readable storage medium comprising instructions executable by the processor to perform steps comprising:
receiving first and second digital jaw models;
determining a rough bite approximation of the first and second digital jaw models;
determining one or more initial bite positions of the first and second digital jaw models from the rough approximation;
determining one or more iterative bite positions of the first and second digital jaw models for each of the one or more initial bite positions;
determining a score for each iterative bite position; and
outputting the bite setting based on the score.

13. The system of claim 12, wherein determining one or more iterative bite positions comprises determining a best transformation of one or more paired points at each iteration.

14. The system of claim 13, wherein the best transformation of one or more paired points at an iteration is used as the initial bite position in the next iteration.

15. The system of claim 13, wherein the one or more paired points comprises an attraction weighted pair.

16. The system of claim 13, wherein the one or more paired points comprises interpenetration weighted pair.

17. The system of claim 12, further comprising performing penetration fixing iterations.

18. The system of claim 12, wherein determining the score comprises summing vertex scores from an extended tooth region, wherein each vertex score is a function of a signed distance from the other jaw.

19. A non-transitory computer readable medium storing executable computer program instructions for determining a bite setting, the computer program instructions comprising instructions for:
receiving first and second digital jaw models;
determining a rough bite approximation of the first and second digital jaw models;
determining one or more initial bite positions of the first and second digital jaw models from the rough approximation;
determining one or more iterative bite positions of the first and second digital jaw models for each of the one or more initial bite positions;
determining a score for each iterative bite position; and
outputting the bite setting based on the score.

20. The medium of claim 19, further comprising performing penetration fixing iterations.
